(19) United States
(12) Patent Application Publication
(10) Pub. No.: US 2014/0115291 A1
(43) Pub. Date: Apr. 24, 2014

(54) NUMA OPTIMIZATION FOR GARBAGE COLLECTION OF MULTI-THREADED APPLICATIONS

(71) Applicant: ADVANCED MICRO DEVICES, INC., Sunnyvale, CA (US)

(72) Inventor: Eric R. Caspole, Bedford, MA (US)

(73) Assignee: ADVANCED MICRO DEVICES, INC., Sunnyvale, CA (US)

(21) Appl. No.: 13/655,782

(22) Filed: Oct. 19, 2012

(51) Int. Cl. G06F 12/02

(52) U.S. Cl. 711/166; 711/E12.009

(57) ABSTRACT

Methods and systems for garbage collection are provided. The method includes and the system is configured for assigning a garbage collection thread to execute on a first node of a plurality of nodes in a non-uniform memory access (NUMA) computing system, determining whether each of a plurality of application threads is a local thread that is active on the first node, and selecting the local thread for garbage collection by the garbage collection thread when the local thread is active on the first node.

### TECHNICAL FIELD

The technical field relates generally relates garbage collection on computing systems, and more particularly relates to garbage collection on non-uniform memory access (NUMA) data processing systems.

### BACKGROUND

When software programmers write applications to perform work according to an algorithm or a method, the programmers often utilize variables to reference temporary and result data. This data, which may be referred to as data objects, requires that space be allocated in computer memory. During execution of one or more applications, the amount of computer memory unallocated, or free, for data object allocation may decrease to a suboptimal level. Such a reduction in the amount of free space may decrease system performance and, eventually, there may not be any free space available. Automatic memory management techniques, such as garbage collection, may be used during application execution. Garbage collection maintains sufficient free space, identifies and removes memory leaks, copies some or all of the reachable data objects into a new area of memory, updates references to data objects as needed, and so on.

Garbage collection algorithms typically include several steps and may be relatively time consuming. Consequently, the computing system may experience a pause while the garbage collection algorithm performs its tasks. If the garbage collector is run in real-time, or concurrent with the execution of applications, the length of the garbage collection pause may be unacceptable. In addition, the algorithm may utilize cache space during its execution. The use of cache space may in turn cause the eviction of useful information that must be re-fetched once the algorithm has finished.

Additionally, some computing systems use multiple processors for higher performance. One type of multiple processor architectures is known as a non-uniform memory access (NUMA) architecture, in which each processor operates on a shared address space, but memory is distributed among the processor nodes and memory access time depends on the location of the data in relation to the processor that needs it. Garbage collection in these NUMA systems may often lead to long pause times due in part to the access time required for a processor to read a memory that is located in a different node.

### SUMMARY OF EMBODIMENTS

Methods and systems for garbage collection are provided. In some embodiments a method includes assigning a garbage collection thread to execute on a first node of a plurality of nodes in a non-uniform memory access (NUMA) computing system, determining whether each of a plurality of application threads is a local thread that is active on the first node, and selecting the local thread for garbage collection by the garbage collection thread when the local thread is active on the first node.

In some embodiments a computing system includes a plurality of nodes that each include a processor and memory. The plurality of nodes include control logic configured to assign a garbage collection thread to execute on a first node of the plurality of nodes, determine whether each of a plurality of application threads is a local thread that is active on the first node, select the local thread for garbage collection by the garbage collection thread when the local thread is active on the first node, and select a remote thread that is active on one of the plurality of nodes other than the first node for garbage collection by the garbage collection thread when no local thread is active on the first node.

In some embodiments a non-transitory computer readable medium is provided. The non-transitory computer readable medium stores control logic for execution by at least one processor of a non-uniform memory access (NUMA) computing system. The control logic includes instructions to assign a garbage collection thread to execute on a first node of the plurality of nodes, determine a node identifier for each of a plurality of application threads that indicates a node on which each of the plurality of application threads is active, store the node identifier to an active thread list, select a local thread for garbage collection by the garbage collection thread when the node identifier indicates that the local thread is active on the first node, and select a remote thread that is active on one of the plurality of nodes other than the first node when the node identifiers indicate that none of the plurality of application threads is active on the first node.

### BRIEF DESCRIPTION OF THE DRAWINGS

Advantages of the embodiments disclosed herein will be readily appreciated, as the same becomes better understood by reference to the following detailed description when considered in connection with the accompanying drawings wherein:

FIG. 1 is a simplified block diagram of a computing system according to some embodiments;

FIG. 2 is a simplified block diagram of virtual machine control logic according to some embodiments; and

FIG. 3 is a flow diagram illustrating a method of collecting garbage in a non-uniform memory access system according to some embodiments.

### DETAILED DESCRIPTION

The following detailed description is merely exemplary in nature and is not intended to limit application and uses. As used herein, the word “exemplary” means “serving as an example, instance, or illustration.” Thus, any embodiments described herein as “exemplary” are not necessarily to be construed as preferred or advantageous over other embodiments. All of the embodiments described herein are exemplary embodiments provided to enable persons skilled in the art to make or use the disclosed embodiments and not to limit the scope of the disclosure which is defined by the claims. Furthermore, there is no intention to be bound by any expressed or implied theory presented in the preceding technical field, background, brief summary, the following detailed description or for any particular computing system.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Finally, for the sake of brevity, conventional techniques and components related to computing systems and other functional aspects of a computing system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in the embodiments disclosed herein.

In general, a method and system for limiting pauses during garbage collection in runtime systems on NUMA computing systems are provided in some embodiments described herein. Garbage collection on application threads that are local to the garbage collection thread is preferred by the method and system to reduce remote memory accesses when scanning the stacks of active application threads.

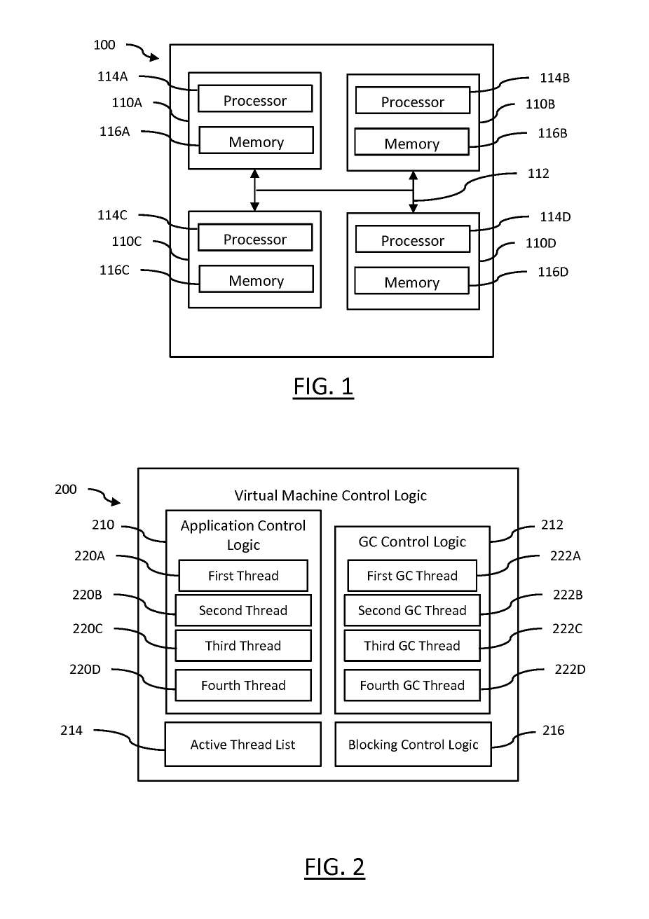

FIG. 1 illustrates a block diagram of a non-uniform memory access (NUMA) system 100 according to some embodiments. The NUMA system 100 provided includes a first node 110A, a second node 110B, a third node 110C, and a fourth node 110D. The nodes 110A-D are coupled for electronic communication by an interconnect 112. The number of nodes, the physical interfaces between nodes, and the communication protocol among the nodes may vary according to some embodiments. Each node 110A-D respectively includes a processor 114A-D and memory 116A-D. The processors 114A-D may include one or more processing cores and include circuitry for executing instructions according to a general-purpose instruction set. For example, the x86 instruction set architecture may be selected. Alternatively, the Alpha, PowerPC, or any other general-purpose instruction set architecture may be selected.

The memories 116A-D may include one or more dynamic random access memories (DRAMs), synchronous DRAMs (SDRAMs), static RAM, or other suitable memory technologies. The memories 116A-D are combined into a contiguous global virtual address space, where a mapping between virtual addresses and physical addresses determines the location of values in physical memory or disk. In some embodiments, each processing node 110 includes a memory map used to determine which addresses are mapped to which memories 116A-D, and hence to which processing node 110 a memory request for a particular address should be routed. In some embodiments, the coherency point for an address within computing system 100 is a memory controller (not shown) coupled to the memory and storing bytes corresponding to the address. The memory controllers may comprise control circuitry for interfacing to memories 116A-D. Additionally, the memory controllers may include request queues for queuing memory requests.

Each of the memories 116A-D in the global address space may be accessed by each of the processors 114A-D. The global address space has non-uniform memory access. In other words, the time for each processor 114A-D to access data stored in the global address space varies based on the physical locations of the processor 114A-D and the memory 116A-D that holds the data. For example, data used by the first processor 114A may be stored in the global address space at the “local” first memory 116A located in the same node 110A as the processor, or the data may be stored in the “remote” memories 116B-D that are located in nodes 110B-D other than the first node 110A. Accesses to remote memory take longer than accesses to local memory due in part to the mechanics of memory retrieval and distances between the nodes that the requests must travel through the interconnect 112 to reach the remote memories.

Practical embodiments of the computing system 100 may include other devices and components for providing additional functions and features. For example, various embodiments of the computing system include components such as additional input/output (I/O) peripherals, memory, interconnects, and memory controllers.

Referring now to FIG. 2, virtual machine 200 control logic is illustrated in simplified block diagram form according to some embodiments. The virtual machine 200 provided is implemented in Java HotSpot Virtual Machine that is delivered as a shared library in the Java Runtime Environment available from Oracle Corporation of Redwood City, Calif. It should be appreciated that other runtime environments and platforms may be incorporated in some embodiments.

The virtual machine 200 includes application control logic 210, garbage collection (GC) control logic 212, active thread list 214 control logic, and blocking control logic 216. The application control logic 210 generally executes software programs in the virtual machine 200 using a plurality of threads. The term “thread” refers to a linear control flow of an executing program. Application threads may also be known as mutator threads. Threads may execute sequentially or concurrently and may execute separate paths in a program simultaneously. For example, different threads may be executing on each of the nodes 110A-D simultaneously. In the example provided, the application control logic 210 includes a first thread 220A, a second thread 220B, a third thread 220C, and a fourth thread 220D. In the example provided, the first through fourth threads 220A-D are assigned to be executed on the first through fourth nodes 110A-D, respectively. It should be appreciated that the number of threads 220A-D may vary and may be distributed among the nodes 110A-D differently.

The threads 220A-D generally use heap and stack data structures that are often stored in the memory 116A-D of the same node 110A-D on which the threads 220A-D are running. In other words, the operating system kernel places and schedules threads so that the thread stack is generally stored in the memory 116A-D that is local to the processor 114A-D that is running the application thread 220A-D. In general, operating system kernals prefer to keep threads on the same node to limit cache misses that occur due to thread migration to another node. For example, the first processor 114A executes the first thread 220A, and a runtime stack and heap data structure used by the first thread 220A are stored in the first memory 116A on the first node 110A. The runtime stack is generally used for local variables and to store the function call return pointer. The stack may be grown and shrunk on a procedure call or return, respectively. In the example provided, pointers to objects in the application memory heap are stored into the stack during the course of execution. The heap may be used to allocate dynamic objects accessed with the pointers. After a function is returned, the stack may have a stack pointer adjusted to direct the application control logic 210 to a different memory address. The heap, on the other hand, may still contain leftover data corresponding to the function that was just returned. In some situations, the leftover data is unreachable or may never be used again by the application control logic. Accordingly, garbage collection may be performed to remove the leftover data.

In some embodiments, garbage collection is performed when an application thread 220A-D attempts to allocate memory and the heap memory is full. In some embodiments, garbage collection is performed on a periodic basis, when background tasks are to be run, or when any other suitable condition is met for initiating garbage collection. For example, garbage collection may be initiated when the system is low on memory. The example provided utilizes a “stop-the-world” garbage collection process where the application control logic 210 is halted during garbage collection. In some embodiments, incremental or concurrent garbage collection processes may be utilized to interleave garbage collection with execution of the application control logic 210.

At a time when a garbage collection is determined to be run, some pre-processing steps are performed before the garbage collection proceeds. When a GC occurs, the application threads 220A-D are stopped by the blocking control logic 216 so that the stacks may be scanned for roots into the heap. These roots help to determine which objects in the heap will remain live after the collection. The blocking control logic 216 halts execution of the application threads 220A-D and restricts access to the portions of the memories 116A-D that are storing the stacks and heaps of the application threads 220A-D. Restricting access to the memories 116A-D limits new allocations of data objects to the heaps during garbage collection. The blocking control logic 216 determines what node 110A-D each application thread 220A-D is assigned to and stores a node identifier that indicates the assigned node 110A-D in the thread list 214. For example, when blocking for the first application thread 220A, the blocking control logic 216 makes a call to the operating system kernel to determine that the first application thread 220A is executing on the first processor 114A of the first node 110A. The blocking control logic 216 then stores the node identifier in the thread list 214 that indicates the first application thread 220A is assigned to the first node 110A. The garbage collector control logic 212 is then able to use the node identifier to perform garbage collection in a NUMA aware manner, as will be described below.

The GC control logic 212 may be executed to clear unreferenced (unused) data from the heap. For example, the leftover data discussed above may be removed because it is no longer being used. In some embodiments, the GC control logic 212 is configured to scan system memory, mark all reachable data objects, delete data objects determined not to be usable or reachable, and move data objects to occupy contiguous locations in memory. The garbage collection algorithm attempts to reclaim garbage, or memory used by objects that will never be accessed or mutated again by the application. In some embodiments, distinction is drawn between syntactic garbage (data objects the program cannot possibly reach), and semantic garbage (data objects the program will in fact never again use). A variety of different garbage collection techniques have been developed and may be implemented.

When a garbage collector is executed to clear unused data, useful data remains in memory by the garbage collector algorithm. In some embodiments, the garbage collection algorithm may develop a list of data objects that need to be kept for later application use. Development of this list may begin with roots, or root addresses. Root addresses may correspond to pointers in the stack and data objects in the heap that are pointed to by a memory address in the node. During a recursive search by the GC control logic 212, data may be determined to be reachable. For example, data may be reachable, in one example, due to being referenced by a pointer in the stack. A reachable object may be defined as data located by a root address or data referenced by data previously determined to be reachable.

The GC control logic 212 includes a first GC thread 222A assigned to the first node 110A, a second GC thread 222B assigned to the second node 110B, a third GC thread 222C assigned to the third node 110C, and a fourth GC thread 222D assigned to the fourth node 110D. The GC control logic 212 creates the GC threads 222A-D when the virtual machine 200 is launched. The GC threads 222A-D parallelize the work of garbage collection to reduce the pause time observed by the application threads.

Each GC thread 222A-D scans the thread list 214 for application threads 220A-D that are active on the same NUMA node 110A-D as the GC thread 222A-D. For example, the first GC thread 222A that is assigned to the first NUMA node 110A scans the thread list 214 and selects for garbage collection the application thread 220A that is active on the first NUMA node 110A. Because the heap and stack of the first application thread 220A are generally assigned to the first memory 116A of the first node 110A where the application thread 220A is active, remote memory accesses during garbage collection are limited by collecting garbage on nodes local to the GC thread 222A-D. For example, Java web application servers may execute web applications with hundreds of threads and very deep call stacks due to the very object oriented programming model. As a result, stack scanning for roots into the heap may be a substantial job to begin the garbage collection. Therefore, reducing the number of remote memory accesses required during stack scanning of the web applications may reduce pause times and improve performance of the virtual machine 200.

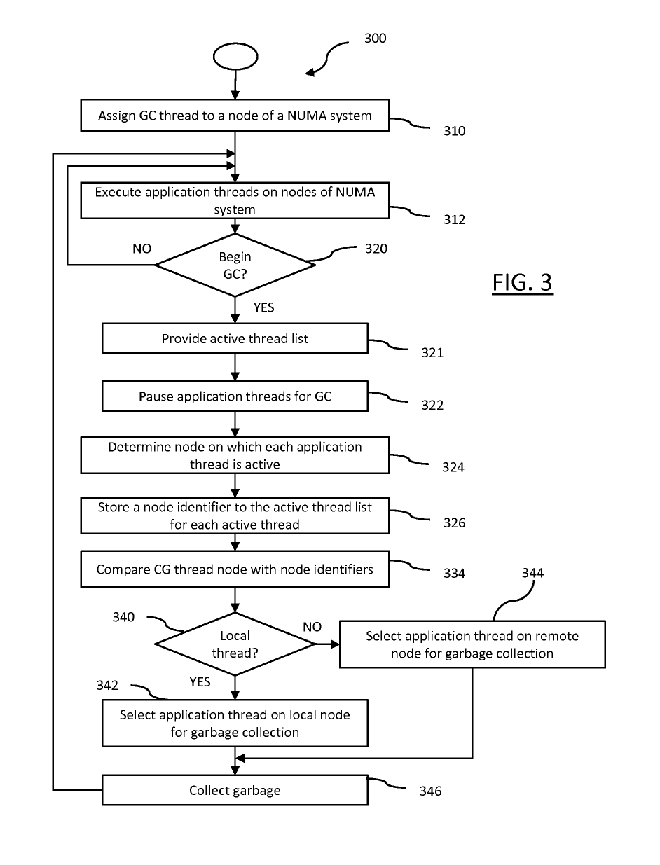

Referring now to FIG. 3, a method 300 of collecting garbage in a NUMA computing system is illustrated. For example, the method 300 may be executed by the virtual machine 200 on the computing system 100. At step 310, a garbage collection thread is assigned to a node of the NUMA system. For example, the first GC thread 222A may be created and assigned to execute on the first processor 114A in the first node 110A of the NUMA computing system 100. Application threads are executed on NUMA nodes by the virtual machine in step 312 until a garbage collection is indicated to begin in step 320. For example, the virtual machine 200 may execute the application threads 220A-D on the nodes 110A-D until an application thread 220A-D attempts to allocate a data object to a full heap. When no garbage collection is indicated to begin, the application threads 220A-D continue executing.

When garbage collection is indicated to begin, an active thread list is provided in step 321 and the application threads 220A-D are paused for garbage collection in step 322. It is determined which node is running the application thread in step 324 and a node identifier is stored in the active thread list in step 326. For example, the blocking control logic 216 may pause the application threads 220A-D, call to the operating system kernel to determine what core is executing each application thread 220A-D, and store a node identifier associated with each application thread 220A-D in the thread list 214.

At step 334 a GC thread compares the node identifiers of the active application threads with an identifier of the node on which the GC thread is executing to determine if any of the application threads is a local thread. The node identifier may be any value that uniquely identifies the nodes of the NUMA system. For example, the GC thread 222A may scan the thread list 214 to find a local thread that is active on the first processor 114A. When the GC thread determines that an application thread is active on the node local to the GC thread in step 340, the GC thread selects the local thread for garbage collection in step 342. For example, the GC thread 222A selects the first application thread 220A that is local to the GC thread 222A for garbage collection. In some embodiments, the active thread list is sorted as the active thread list is created. In some embodiments, separate thread lists are created for each node of the system.

When no application threads are active on the node local to the GC thread, the GC thread selects an application thread that is active on a remote node for garbage collection in step 344. For example, when the first application thread 220A is not active, the GC thread 222A may select the second application thread 220B for garbage collection. In some embodiments, an application thread is selected to reduce memory access time to the remote node. For example, in a system where memory access time from the first node 110A to the second node 110B is less than the access time from the first node 110A to the third node 110C, the GC thread 222A selects an application thread that is active on the second node 110B for garbage collection.

The GC thread collects garbage in step 346. For example, the GC thread may scan the stack of the selected application thread for roots, or reference pointers into the heap. Because the operating system kernel generally allocates local memory for each application thread, the GC thread generally scans local memory when a local application thread is available for garbage collection. Accordingly, by selecting threads that are local to the GC thread, the GC thread may limit remote memory access delays during thread scanning. For example, in a system where local memory access takes 100 ns and the remote memory access takes 175 ns, each cache missing request to scan a stack frame will save 75 ns if it is a local request. Therefore, with NUMA locality taken into account while scanning dozens of threads in a typical web server application, the method 300 may save microseconds of time by targeting each GC thread at local thread stacks.

A data structure representative of the computing system 100 and/or portions thereof included on a computer readable storage medium may be a database or other data structure which can be read by a program and used, directly or indirectly, to fabricate the hardware comprising the computing system 100. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the computing system 100. The netlist may then be placed and routed to produce a data set describing geometric shapes to be applied to masks. The masks may then be used in various semiconductor fabrication steps to produce a semiconductor circuit or circuits corresponding to the computing system 100. Alternatively, the database on the computer readable storage medium may be the netlist (with or without the synthesis library) or the data set, as desired, or Graphic Data System (GDS) II data.

The method illustrated in FIG. 3 may be governed by instructions that are stored in a non-transitory computer readable storage medium and that are executed by at least one processor of the computing system 100. Each of the operations shown in FIG. 3 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

The provided method and control logic have several beneficial attributes that promote increased performance in a NUMA computing system. The overhead/slow performance of garbage collection can reduce the performance of the user application in a garbage collected runtime system. For example, the performance of garbage collection in runtime systems is improved by reducing remote node memory requests during garbage collection. Performance bottlenecks caused by poor NUMA behavior are reduced and the reduced pause time is generally observed by the application running in the garbage collected system.

While at least one exemplary embodiment has been presented in the foregoing detailed description of the disclosed embodiments, it should be appreciated that a vast number of variations exist. It should also be appreciated that the exemplary embodiment or exemplary embodiments are only examples, and are not intended to limit the scope, applicability, or configuration of the disclosed embodiments in any way. Rather, the foregoing detailed description will provide those skilled in the art with a convenient road map for implementing the disclosed embodiments, it being understood that various changes may be made in the function and arrangement of elements of the disclosed embodiments without departing from the scope of the disclosed embodiments as set forth in the appended claims and their legal equivalents.

What is claimed is:

1. A method comprising:
assigning a garbage collection thread to execute on a first node of a plurality of nodes in a non-uniform memory access (NUMA) computing system;
determining whether each of a plurality of application threads is a local thread that is active on the first node; and
selecting the local thread for garbage collection by the garbage collection thread when the local thread is active on the first node.

2. The method of claim 1 further including providing an active thread list that indicates what application threads are active threads on the NUMA computing system, and further including storing a node identifier to the active thread list that indicates the node on which each of the active threads is active.

3. The method of claim 2 further including pausing execution of the plurality of application threads with a blocking control logic, and wherein storing the node identifier includes calling to an operating system kernel to determine the node identifier when the blocking control logic pauses execution of the plurality of application threads.

4. The method of claim 2 wherein determining whether each of the plurality of application threads is a local thread includes comparing an identifier of the first node with the node identifiers stored in the active thread list.

5. The method of claim 1 further including selecting a remote thread that is active on one of the plurality of nodes other than the first node when no local thread is active on the first node.

6. The method of claim 1 further including collecting garbage of the selected local thread with the garbage collection thread.

7. A computing system comprising:
a plurality of nodes each including a processor and a memory, the plurality of nodes including control logic configured to:
assign a garbage collection thread to execute on a first node of the plurality of nodes;
determine whether each of a plurality of application threads is a local thread that is active on the first node;
select the local thread for garbage collection by the garbage collection thread when the local thread is active on the first node; and
select a remote thread that is active on one of the plurality of nodes other than the first node for garbage collection by the garbage collection thread when no local thread is active on the first node.

8. The computing system of claim 7 wherein the control logic is configured to provide an active thread list that indicates what application threads are active threads on the NUMA computing system.

9. The computing system of claim 8 wherein the control logic is configured to store a node identifier to the active thread list that indicates the node on which each of the active threads is active.

10. The computing system of claim 9 wherein the control logic is configured to pause execution of the plurality of application threads and call to an operating system kernel to determine the node identifier when pausing the execution of the plurality of application threads.

11. The computing system of claim 9 wherein the control logic is configured to compare an identifier of the first node with the node identifiers stored in the active thread list.

12. The computing system of claim 9 wherein the control logic is configured to assign a separate garbage collection thread to each of the plurality of nodes and select an application thread for each of the separate garbage collection threads based on the node identifier stored in the active thread list.

13. The computing system of claim 7 wherein the control logic is configured to collect garbage of the selected local thread with the garbage collection thread.

14. A non-transitory computer readable medium storing control logic for execution by at least one processor of a non-uniform memory access (NUMA) computing system, the control logic comprising instructions to:
assign a garbage collection thread to execute on a first node of a plurality of nodes;
determine a node identifier for each of a plurality of application threads that indicates a node on which each of the plurality of application threads is active;
store the node identifier to an active thread list;
select a local thread for garbage collection by the garbage collection thread when the node identifier indicates that the local thread is active on the first node; and
select a remote thread that is active on one of the plurality of nodes other than the first node when the node identifiers indicate that none of the plurality of application threads is active on the first node.

15. The computer readable medium of claim 14 wherein the control logic includes instructions to pause execution of the plurality of application threads and call to an operating system kernel to determine the node identifier when pausing execution of the plurality of application threads.

16. The computer readable medium of claim 14 wherein the control logic includes instructions to compare an identifier of the first node with the node identifiers stored in the active thread list.

17. The computer readable medium of claim 14 wherein the control logic includes instructions to assign a separate garbage collection thread to each of the plurality of nodes and select an application thread for each of the separate garbage collection threads based on the node identifier stored in the active thread list.

18. The computer readable medium of claim 14 wherein the control logic includes instructions to collect garbage of the selected local thread with the garbage collection thread.
